(19) United States
(12) Patent Application Publication
(10) Pub. No.: US 2026/0175090 A1
(43) Pub. Date: Jun. 25, 2026

(54) GOLF BALL

(71) Applicant: Sumitomo Rubber Industries, Ltd., Kobe-shi (JP)

(72) Inventors: Ayaka SHINDO, Kobe-shi (JP); Takahiro SHIGEMITSU, Kobe-shi (JP)

(73) Assignee: Sumitomo Rubber Industries, Ltd., Kobe-shi (JP)

(21) Appl. No.: 19/422,723

(22) Filed: Dec. 17, 2025

(30) Foreign Application Priority Data
Dec. 25, 2024 (JP) 2024-229112
Aug. 20, 2025 (JP) 2025-137041

(51) Int. Cl. A63B 37/00; C08G 18/75; C08K 5/092

(52) U.S. Cl. CPC A63B 37/0074; A63B 37/0031; C08G 18/758; C08K 5/092; A63B 2209/00

(57) ABSTRACT

An object of the present disclosure is, for a golf ball comprising a cover containing a polyurethane as a resin component, to improve formability of the cover and increase productivity of the golf ball while inhibiting lowering of scratch resistance of the cover. The present disclosure provides a golf ball comprising a spherical core and a cover covering the spherical core, wherein the cover is formed from a cover composition containing (A) a thermoplastic polyurethane and (B) a carboxylic acid having a molecular weight of 1000 or less as a resin component.

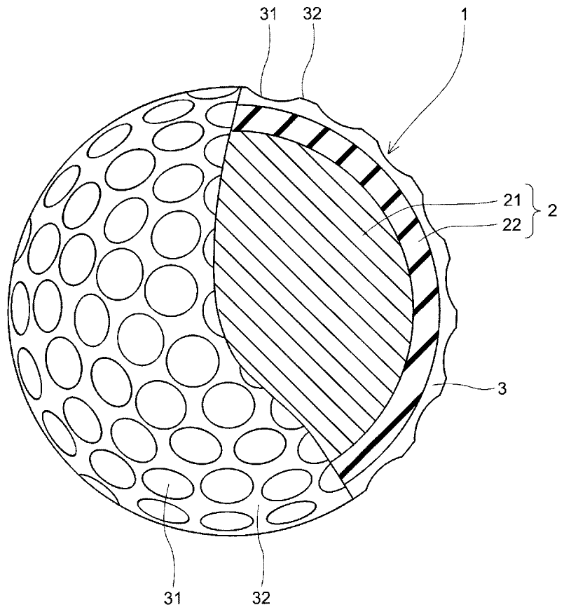

### FIELD OF THE PRESENT DISCLOSURE

The present disclosure relates to a golf ball, and particularly relates to a technology for improving formability of a polyurethane cover.

### DESCRIPTION OF THE RELATED ART

Conventionally, as a resin component constituting a cover of a golf ball, an ionomer resin or a polyurethane is used. A cover using an ionomer resin tends to have excellent resilience, durability, processability and the like. A cover using a polyurethane tends to have improved shot feeling or spin performance. In addition, a cover material using an ionomer resin and a polyurethane in combination has also been proposed.

For example, JP H11-137726 A discloses a multi-piece solid golf ball comprising a solid core and a dual layered cover composed of an inner layer and an outer layer and covering the solid core, wherein the inner cover is primarily formed from an ionomer resin including at least 15 wt % of an a, B-unsaturated carboxylic acid, the outer cover is primarily formed from a thermoplastic elastomer not including an ionomer resin, and an adhesive primarily containing a thermoplastic resin is blended into at least one cover material of the inner cover and the outer cover.

In addition, JP 2007-537014 A discloses a golf ball comprising a core layer and a cover layer, wherein at least one of said layers comprises a polytrimethylene ether glycol composition.

### SUMMARY OF THE DISCLOSURE

When a polyurethane is primarily used as a resin component of a cover composition, the cover composition tends to have lowered fluidity, and there is a problem that the cover is hard to be formed. Here, if an ionomer resin is added into the cover composition containing the polyurethane, the fluidity of the cover composition can be improved. However, if the ionomer resin is added into the polyurethane, there is a problem that the formed cover has lowered scratch resistance.

The present disclosure has been made in view of the above circumstances, and an object of the present disclosure is, with respect to a golf ball comprising a cover containing a polyurethane as a resin component, to improve formability of the cover and enhance productivity of the golf ball while inhibiting lowering of scratch resistance of the cover.

The present disclosure that has solved the above problem provides a golf ball comprising a spherical core and a cover covering the spherical core, wherein the cover is formed from a cover composition containing (A) a thermoplastic polyurethane and (B) a carboxylic acid having a molecular weight of 1000 or less as a resin component.

According to the present disclosure, with respect to a golf ball comprising a cover containing a polyurethane as a resin component, formability of the cover can be improved and productivity of the golf ball can be enhanced while inhibiting lowering of scratch resistance of the cover.

### BRIEF DESCRIPTION OF THE DRAWINGS

The FIGURE is a partially cutaway cross-sectional view showing a golf ball according to one embodiment of the present disclosure.

### DESCRIPTION OF THE PREFERRED EMBODIMENT

The present disclosure provides a golf ball comprising a spherical core and a cover covering the spherical core, wherein the cover is formed from a cover composition containing (A) a thermoplastic polyurethane and (B) a carboxylic acid having a molecular weight of 1000 or less (hereinafter, sometimes simply referred to as “(B) the carboxylic acid”) as a resin component.

If (B) the carboxylic acid is blended into (A) the thermoplastic polyurethane, the melt viscosity of the cover composition can be lowered, and the formability of the cover composition can be enhanced. In addition, (B) the carboxylic acid hardly impairs the flexibility of (A) the thermoplastic polyurethane, and lowering of the scratch resistance of the obtained cover can be inhibited.

### [Cover Composition]

The cover composition used in the present disclosure will be explained. The cover composition contains (A) a thermoplastic polyurethane and (B) a carboxylic acid as a resin component.

### ((A) Thermoplastic Polyurethane)

The cover composition contains (A) a thermoplastic polyurethane as a resin component.
(A) The thermoplastic polyurethane is a material having a plurality of urethane bonds in the molecule and exhibiting thermoplasticity. The thermoplastic polyurethane is a polyurethane exhibiting plasticity by heating and generally means a polyurethane having a linear chain structure of a high molecular weight to a certain extent. Examples of (A) the thermoplastic polyurethane include a product having urethane bonds formed in the molecule by a reaction between a polyisocyanate and a polyol.

The polyisocyanate constituting (A) the thermoplastic polyurethane is not particularly limited, as long as the polyisocyanate is a compound having at least two isocyanate groups in the molecule. The polyisocyanate may be used solely, or at least two of them may be used in combination. The polyisocyanate is preferably a diisocyanate having two isocyanate groups in the molecule.

Examples of the polyisocyanate include an aromatic polyisocyanate such as 2,4-toluene diisocyanate, 2,6-toluene diisocyanate, a mixture of 2,4-toluene diisocyanate and 2,6-toluene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI); and an alicyclic or aliphatic polyisocyanate such as 4,4′-dicyclohexylmethane diisocyanate (H₁₂MDI), 1,3-bis(isocyanatomethyl) cyclohexane (H₆XDI), hexamethylene diisocyanate (HDI), isophorone diisocyanate (IPDI), trans-1,4-cyclohexane diisocyanate (CHDI), and norbornene diisocyanate (NBDI). Among these, as the polyisocyanate, the alicyclic diisocyanate and/or the aromatic diisocyanate is preferable. If the alicyclic diisocyanate and/or the aromatic diisocyanate is used, the obtained polyurethane has enhanced mechanical properties, and the obtained cover has further enhanced scratch resistance.

As the polyisocyanate of (A) the thermoplastic polyurethane, at least one diisocyanate selected from the group consisting of 4,4′-dicyclohexylmethane diisocyanate (H₁₂MDI), 1,3-bis(isocyanatomethyl)cyclohexane (H₆XDI), isophorone diisocyanate (IPDI), trans-1,4-cyclohexane diisocyanate (CHDI), 4,4′-diphenylmethane diisocyanate (MDI) and toluene diisocyanate (TDI) is preferable, 4,4′-dicyclohexylmethane diisocyanate (H₁₂MDI) or 4,4′-diphenylmethane diisocyanate (MDI) is particularly preferable. If the above diisocyanate is used, the obtained polyurethane has enhanced mechanical properties, and the obtained cover has further enhanced scratch resistance.

In addition, as the polyisocyanate of (A) the thermoplastic polyurethane, the non-yellowing polyisocyanate (TMXDI, XDI, HDI, H₆XDI, IPDI, H₁₂MDI, NBDI, etc.) is preferably used, and 4,4′-dicyclohexylmethane diisocyanate (H₁₂MDI) is more preferably used, from the viewpoint of improving the weather resistance of the cover. The 4,4′-dicyclohexylmethane diisocyanate (H₁₂MDI) has a rigid structure, and thus the obtained polyurethane has further enhanced mechanical properties.

The polyol constituting (A) the thermoplastic polyurethane is not particularly limited, as long as the polyol is a compound having at least two hydroxy groups in the molecule, and examples thereof include a high molecular weight polyol. The high molecular weight polyol may be used solely, or at least two of them may be used in combination. As the polyol, a diol having two hydroxy groups in the molecule is preferable.

Examples of the high molecular weight polyol include a polyether polyol such as polyoxyethylene glycol (PEG), polyoxypropylene glycol (PPG), polytrimethylene ether glycol (PO3G) and polyoxytetramethylene glycol (PTMG); a condensed polyester polyol such as polyethylene adipate (PEA), polybutylene adipate (PBA) and polyhexamethylene adipate (PHMA); a lactone polyester polyol such as poly-ε-caprolactone (PCL); a polycarbonate polyol such as polyhexamethylene carbonate; and an acrylic polyol. The high molecular weight polyol may be derived from a petroleum resource or a biomass resource.

The number average molecular weight of the high molecular weight polyol is not particularly limited, and for example, is preferably 400 or more, more preferably 1,000 or more, and is preferably 10,000 or less, more preferably 8,000 or less.
(A) The thermoplastic polyurethane may include a chain extender as the constituent component. As the chain extender component, a low molecular weight polyol, a low molecular weight polyamine or the like can be used.

Examples of the low molecular weight polyol include a diol such as ethylene glycol, diethylene glycol, triethylene glycol, propane diol (e.g. 1,2-propane diol, 1,3-propane diol, 2-methyl-1,3-propane diol), dipropylene glycol, butane diol (e.g. 1,2-butane diol, 1,3-butane diol, 1,4-butane diol, 2,3-butane diol, 2,3-dimethyl-2,3-butane diol), neopentyl glycol, pentane diol, hexane diol, heptane diol, octane diol, 1,6-cyclohexane dimethylol, aniline diol, and bisphenol A diol; a triol such as glycerin, trimethylolpropane, and hexane triol; and a tetraol or hexaol such as pentaerythritol, and sorbitol.

In addition, the low molecular weight polyamine used as the chain extender component is not particularly limited, as long as the polyamine has at least two amino groups. Examples of the polyamine include an aliphatic polyamine such as ethylene diamine, propylene diamine, butylene diamine, and hexamethylene diamine; an alicyclic polyamine such as isophorone diamine and piperazine; and an aromatic polyamine.

The aromatic polyamine is not particularly limited, as long as the aromatic polyamine has at least two amino groups directly or indirectly bonded to an aromatic ring. Herein, the “indirectly bonded” means that the amino group is bonded to the aromatic ring via, for example, a lower alkylene bond. The aromatic polyamine may be, for example, a monocyclic aromatic polyamine having at least two amino groups bonded to one aromatic ring, or a polycyclic aromatic polyamine having at least two aminophenyl groups each having at least one amino group bonded to one aromatic ring.

Examples of the monocyclic aromatic polyamine include a type having the amino groups directly bonded to the aromatic ring, such as phenylene diamine, toluene diamine, diethyltoluene diamine, and dimethylthiotoluene diamine; and a type having the amino groups bonded to the aromatic ring via the lower alkylene bond, such as xylylene diamine.

In addition, the polycyclic aromatic polyamine may be a poly (aminobenzene) having at least two aminophenyl groups directly bonded to each other, or a compound having at least two aminophenyl groups bonded to each other via a lower alkylene group or an alkylene oxide group. Among them, a diaminodiphenyl alkane having two aminophenyl groups bonded to each other via a lower alkylene group is preferable. Particularly, 4,4′-diaminodiphenyl methane or the derivative thereof is preferable.

The molecular weight of the chain extender is preferably less than 400, more preferably 350 or less, and even more preferably 200 or less, and is preferably 30 or more, more preferably 40 or more, and even more preferably 45 or more.

The constitution embodiment of (A) the thermoplastic polyurethane is not particularly limited, and examples thereof include an embodiment that (A) the thermoplastic polyurethane is composed of the polyisocyanate and the high molecular weight polyol; an embodiment that (A) the thermoplastic polyurethane is composed of the polyisocyanate, the high molecular weight polyol and the low molecular weight polyol; an embodiment that (A) the thermoplastic polyurethane is composed of the polyisocyanate, the high molecular weight polyol, the low molecular weight polyol and the polyamine; and an embodiment that (A) the thermoplastic polyurethane is composed of the polyisocyanate, the high molecular weight polyol and the polyamine. As the constitution embodiment of (A) the thermoplastic polyurethane, in particular, an embodiment that (A) the thermoplastic polyurethane is composed of the diisocyanate and the diol is preferable, and an embodiment that (A) the thermoplastic polyurethane is composed of the diisocyanate, the high molecular weight diol and the low molecular weight diol is more preferable.

The amount of the polyol in 100 mass % of (A) the thermoplastic polyurethane is preferably 10 mass % or more, more preferably 15 mass % or more, and even more preferably 20 mass % or more, and is preferably 90 mass % or less, more preferably 85 mass % or less, and even more preferably 80 mass % or less.

The amount of the polyisocyanate in 100 mass % of (A) the thermoplastic polyurethane is preferably 10 mass % or more, more preferably 15 mass % or more, and even more preferably 20 mass % or more, and is preferably 90 mass % or less, more preferably 85 mass % or less, and even more preferably 80 mass % or less.

The slab hardness of (A) the thermoplastic polyurethane is preferably 25 or more, more preferably 26 or more, and even more preferably 28 or more, and is preferably 40 or less, more preferably 39 or less, and even more preferably 38 or less in Shore D hardness. If the hardness of (A) the thermoplastic polyurethane is 25 or more in Shore D hardness, the spin rate on driver shots can be lowered, and if the hardness of (A) the thermoplastic polyurethane is 40 or less in Shore D hardness, the spin rate on approach shots increases.

The amount of (A) the thermoplastic polyurethane in the resin component is preferably 50 mass % or more, more preferably 55 mass % or more, even more preferably 60 mass % or more, particularly preferably 70 mass % or more, and most preferably 80 mass % or more, and is preferably 99.9 mass % or less, more preferably 99.5 mass % or less, and even more preferably 99.0 mass % or less. If the amount of the component (A) is 50 mass % or more, the cover has better scratch resistance, and if the amount of the component (A) is 99.9 mass % or less, the cover composition has higher formability.

### ((B) Carboxylic Acid)

The cover composition contains (B) a carboxylic acid having a molecular weight of 1000 or less as a resin component.
(B) The carboxylic acid is a compound having at least one carboxy group in the molecule. (B) The carboxylic acid may be used solely, or at least two of them may be used in combination.

Addition of (B) the carboxylic acid having the low molecular weight to (A) the thermoplastic polyurethane lowers the melt viscosity of the cover composition, and enhances the moldability of the cover composition. In addition, (B) the carboxylic acid has a carboxy group and has an effect of reducing the hydrogen bond of (A) the thermoplastic polyurethane when the cover composition is melted and molded at a high temperature, thus the softness of (A) the thermoplastic polyurethane is hardly impaired, and lowering of the scratch resistance of the obtained cover can be inhibited.

For example, when (A) the thermoplastic polyurethane comprises 4, 4′-dicyclohexylmethane diisocyanate (H₁₂MDI) as the polyisocyanate, if (B) the carboxylic acid is added, the moldability of the cover can be enhanced while inhibiting the lowering of the scratch resistance of the cover.

In addition, for example, when (A) the thermoplastic polyurethane comprises 4, 4′-diphenylmethane diisocyanate (MDI) as the polyisocyanate, addition of (B) the carboxylic acid enhances the scratch resistance of the cover as well as the moldability of the cover. It is noted that although the reason why the scratch resistance as well as the moldability of the cover can be enhanced is unclear, it is considered that this is because (B) the carboxylic acid has an effect of promoting the recombination of (A) the thermoplastic polyurethane after thermal decomposition.

The molecular weight of (B) the carboxylic acid is preferably 50 or more, more preferably 80 or more, and even more preferably 100 or more, and is preferably 1000 or less, more preferably 950 or less, and even more preferably 900 or less. If the molecular weight of (B) the carboxylic acid is 50 or more, volatilization of the carboxylic acid is inhibited when the cover composition is melted, and if the molecular weight of (B) the carboxylic acid is 1000 or less, the improvement effect in the scratch resistance of the cover can be exerted with a small amount of (B) the carboxylic acid.

The number of the carboxy group in the molecule of (B) the carboxylic acid is 1 or more, preferably 2 or more, and is preferably 10 or less, more preferably 8 or less, and even more preferably 5 or less. If the number of the carboxy group in the molecule of (B) the carboxylic acid is 2 or more, the effect of reducing the hydrogen bond of (A) the thermoplastic polyurethane is greater when the cover composition is melted and molded at a high temperature, and if the number of the carboxy group in the molecule of (B) the carboxylic acid is 10 or less, the dispersibility of (B) the carboxylic acid in (A) the thermoplastic polyurethane increases.

The amount of the carboxy group per unit mass of (B) the carboxylic acid is preferably 1 mmol/g or more, more preferably 2 mmol/g or more, and even more preferably 3 mmol/g or more, and is preferably 30 mmol/g or less, more preferably 25 mmol/g or less, and even more preferably 20 mmol/g or less. If the amount of the carboxy group per unit mass of (B) the carboxylic acid is 1 mmol/g or more, the moldability of the cover composition is further enhanced, and if the amount of the carboxy group per unit mass of (B) the carboxylic acid is 30 mmol/g or less, (B) the carboxylic acid has better compatibility with (A) the thermoplastic polyurethane.
(B) The carboxylic acid may have a functional group other than the carboxy group. Examples of the functional group include a hydroxy group, a carbonyl group, and an ester group.

As (B) the carboxylic acid, a hydroxy acid is also preferably used. The hydroxy acid is a compound having at least one carboxy group and at least one hydroxy group in the molecule. The number of the hydroxy group in the molecule of the hydroxy acid is 1 or more, and is preferably 10 or less, more preferably 9 or less, and even more preferably 8 or less. If the number of the hydroxy group in the molecule of the hydroxy acid is 10 or less, the dispersibility of (B) the carboxylic acid in (A) the thermoplastic polyurethane increases.

Examples of the carboxylic acid include an aliphatic carboxylic acid, an aromatic carboxylic acid, an aliphatic hydroxy acid, and an aromatic hydroxy acid.

As the aliphatic carboxylic acid, a saturated aliphatic carboxylic acid or an unsaturated aliphatic carboxylic acid can be used.

Examples of the saturated aliphatic carboxylic acid include a saturated aliphatic monocarboxylic acid, such as butyric acid, valeric acid, caproic acid, enanthic acid, caprylic acid, pelargonic acid, capric acid, lauric acid, myristic acid, pentadecanoic acid, palmitic acid, margaric acid, stearic acid, arachidic acid, behenic acid, lignoceric acid, cerotic acid, montanoic acid, and melissic acid; a saturated aliphatic dicarboxylic acid, such as oxalic acid, malonic acid, succinic acid, glutaric acid, adipic acid, pimelic acid, cork acid (suberic acid), azelaic acid, sebacic acid, and dodecane diacid; and a saturated aliphatic tricarboxylic acid, such as tricarballylic acid.

Examples of the unsaturated aliphatic carboxylic acid include an unsaturated aliphatic monocarboxylic acid, such as myristoleic acid, palmitoleic acid, oleic acid, elaidic acid, vaccenic acid, gadoleic acid, eicosenoic acid, erucic acid, nervonic acid, linoleic acid, linolenic acid, and arachidonic acid; and an unsaturated aliphatic dicarboxylic acid, such as maleic acid, fumaric acid, citraconic acid, and mesaconic acid.

The aromatic carboxylic acid is not particularly limited, as long as the aromatic acid is a compound having an aromatic ring and a carboxy group. Examples of the aromatic carboxylic acid include an aromatic monocarboxylic acid, such as benzoic acid, toluic acid, xylic acid, prehnitylic acid, γ-isodurylic acid, durylic acid, β-isodurylic acid, α-isodurylic acid, cumic acid, α-toluic acid, hydratropic acid, and hydrocinnamic acid; an aromatic dicarboxylic acid, such as phthalic acid, isophthalic acid, terephthalic acid, diphenic acid, and uvitic acid; an aromatic tricarboxylic acid, such as hemimellitic acid, trimellitic acid, and trimesic acid; an aromatic tetracarboxylic acid, such as mellophanic acid and pyromellitic acid; and an aromatic hexacarboxylic acid, such as mellitic acid.

Examples of the aliphatic hydroxy acid include an aliphatic hydroxy acid having one carboxy group, such as glycolic acid, lactic acid, glyceric acid, 2-hydroxybutyric acid, 3-hydroxybutyric acid, 3-hydroxyisobutyric acid, γ-hydroxybutyric acid, leucic acid, mevalonic acid, pantoic acid, ricinoleic acid, ricinoelaidic acid, quinic acid, shikimic acid, 3-hydroxypropionic acid, γ-hydroxyvaleric acid, 3-hydroxyisovaleric acid, and dimethylolbutanoic acid; an aliphatic hydroxy acid having two carboxy groups, such as tartronic acid, malic acid, tartaric acid, and citramalic acid; and an aliphatic hydroxy acid having three carboxy groups, such as citric acid, hydroxycitric acid, and isocitric acid.

Examples of the aromatic hydroxy acid include an aromatic hydroxy acid having one carboxy group, such as salicylic acid, 3-hydroxybenzoic acid, 4-hydroxybenzoic acid, vanillic acid, syringic acid, protocatechuic acid, gentisic acid, orsellinic acid, gallic acid, mandelic acid, 4-hydroxymandelic acid, benzilic acid, phloretic acid, cumaric acid, caffeic acid, ferulic acid, and sinapic acid.

The amount of (B) the carboxylic acid in the resin component is preferably 0.1 mass % or more, more preferably 0.5 mass % or more, and even more preferably 1.0 mass % or more, and is preferably 30 mass % or less, more preferably 20 mass % or less, and even more preferably 15 mass % or less. If the amount of the component (B) is 0.1 mass % or more, the cover composition has further enhanced formability, and if the amount of the component (B) is 30 mass % or less, lowering of the scratch resistance of the obtained cover can be further controlled.

The mass ratio ((A)/(B)) of (A) the thermoplastic polyurethane to (B) the carboxylic acid in the resin component is preferably 70/30 or more, more preferably 80/20 or more, and even more preferably 90/10 or more, and is preferably 99.9/0.1 or less, more preferably 99.5/0.5 or less, and even more preferably 99.0/1.0 or less. If the mass ratio ((A)/(B)) is 70/30 or more, lowering of the scratch resistance of the obtained cover can be further controlled, and if the mass ratio ((A)/(B)) is 99.9/0.1 or less, the cover composition has further enhanced formability.

The molar amount of (B) the carboxylic acid in 100 g of the resin component is preferably 0.1 mmol or more, more preferably 0.2 mmol or more, and even more preferably 0.3 mmol or more, and is preferably 60 mmol or less, more preferably 55 mmol or less, and even more preferably 50 mmol or less. If the molar amount of the component (B) is 0.1 mmol or more, the moldability of the cover composition is further enhanced, and if the molar amount of the component (B) is 60 mmol or less, the component (B) has better compatibility with (A) the thermoplastic polyurethane.

The molar amount of the carboxy group derived from (B) the carboxylic acid in 100 g of the resin component is preferably 0.1 mmol or more, more preferably 0.3 mmol or more, and even more preferably 0.5 mmol or more, and is preferably 100 mmol or less, more preferably 95 mmol or less, and even more preferably 90 mmol or less. If the molar amount of the carboxy group derived from the component (B) is 0.1 mmol or more, the moldability of the cover composition is further enhanced, and if the molar amount of the carboxy group derived from the component (B) is 100 mmol or less, the component (B) has better compatibility with (A) the thermoplastic polyurethane.

### (Other Resin Components)

The resin component of the cover composition may consist of (A) the thermoplastic polyurethane and (B) the carboxylic acid, or may further include other resin components in addition to these components (A) and (B).

Examples of the other resin components include a thermoplastic elastomer.

Specific examples of the thermoplastic elastomer include a thermoplastic polyamide elastomer such as “Pebax (registered trademark) (e.g. “Pebax 2533”)” available from Arkema Inc.; a thermoplastic polyester elastomer such as “Hytrel (registered trademark) (e.g. “Hytrel 3548”, “Hytrel 4047”)” available from Toray Celanese Co., Ltd.; and a thermoplastic polystyrene elastomer such as “Tefabloc (registered trademark)” available from Mitsubishi Chemical Corporation.

When the resin component other than the component (A) and the component (B) is contained, the total amount of the component (A) and the component (B) in the resin component is preferably 85 mass % or more, more preferably 90 mass % or more, and even more preferably 95 mass % or more.

### (Additive)

The cover composition may further contain a pigment component such as titanium oxide and a blue pigment, a weight adjusting agent such as calcium carbonate and barium sulfate, a dispersant, an antioxidant, an ultraviolet absorber, a light stabilizer, a fluorescent material or fluorescent brightener, or the like, as long as they do not impair the performance of the cover. The amount of the resin component in the cover composition is preferably 90 mass % or more, more preferably 92 mass % or more, and even more preferably 94 mass % or more.

The amount of the white pigment (e.g. titanium oxide) is preferably 0.5 part by mass or more, more preferably 1 part by mass or more, and even more preferably 1.5 parts by mass or more, and is preferably 10 parts by mass or less, more preferably 8 parts by mass or less, and even more preferably 6 parts by mass or less, with respect to 100 parts by mass of the resin component. If the amount of the white pigment is 0.5 part by mass or more, it is possible to impart the opacity to the cover, and if the amount of the white pigment is 10 parts by mass or less, lowering of the durability of the cover can be inhibited.

The cover composition can be obtained, for example, by dry blending the component (A), the component (B), and the optional other additives or the like. In addition, the dry blended mixture may be extruded into a pellet form. For dry blending, for example, a mixer that can mix materials in a pellet form is preferably used, and a tumbler mixer is more preferably used. In the extrusion, a conventional extruder such as a single-screw extruder, a twin-screw extruder, and a twin screw-single screw extruder can be used.

The slab hardness of the cover composition is preferably 25 or more, more preferably 26 or more, and even more preferably 28 or more, and is preferably 40 or less, more preferably 39 or less, and even more preferably 38 or less in Shore D hardness. If the slab hardness is 25 or more in Shore D hardness, the spin rate on driver shots can be lowered, and if the slab hardness is 40 or less in Shore D hardness, the spin rate on approach shots increases.

### [Golf Ball]

The golf ball according to the present disclosure comprises a spherical core and a cover covering the spherical core, wherein the cover is formed from the above cover composition. The cover constitutes the outermost layer of the golf ball body. It is noted that the present disclosure relates to the formability and scratch resistance of the cover, and the constitution or the like of the spherical core is not limited.

### (Spherical Core)

Examples of the spherical core include a single layered spherical core; a spherical core composed of a center and one intermediate layer covering the center; and a spherical core composed of a center and two or more intermediate layers covering the center.

A conventionally known rubber composition (hereinafter sometimes simply referred to as “core rubber composition”) may be used for the spherical core or center, and the spherical core or center may be formed by heat pressing, for example, a rubber composition containing a base rubber, a co-crosslinking agent and a crosslinking initiator.

As the base rubber, particularly preferred is a high cis-polybutadiene having a cis-bond in an amount of 40 mass % or more, preferably 70 mass % or more, and more preferably 90 mass % or more in view of its advantageous resilience.

As the co-crosslinking agent, an α,β-unsaturated carboxylic acid having 3 to 8 carbon atoms or a metal salt thereof is preferable, and acrylic acid or a metal salt thereof, methacrylic acid or a metal salt thereof is more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. When the a, B-unsaturated carboxylic acid having 3 to 8 carbon atoms is used as the co-crosslinking agent, a metal compound (e.g. magnesium oxide) is preferably used in combination.

As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and even more preferably 0.4 part by mass or more, and is preferably 5 parts by mass or less, more preferably 4 parts by mass or less, and even more preferably 3 parts by mass or less, with respect to 100 parts by mass of the base rubber.

In addition, the core rubber composition may further contain an organic sulfur compound. As the organic sulfur compound, diphenyl disulfides, thiophenols or thionaphthols are preferably used. The amount of the organic sulfur compound is preferably 0.1 part by mass or more, more preferably 0.3 part by mass or more, and even more preferably 0.5 part by mass or more, and is preferably 5.0 parts by mass or less, more preferably 4.0 parts by mass or less, and even more preferably 2.0 parts by mass or less, with respect to 100 parts by mass of the base rubber.

The core rubber composition may further contain a carboxylic acid and/or a salt thereof. As the carboxylic acid and/or the salt thereof, a carboxylic acid having 1 to 30 carbon atoms and/or a salt thereof is preferred. As the carboxylic acid, an aliphatic carboxylic acid or an aromatic carboxylic acid (e.g. benzoic acid) may be used. The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, or a colored powder, in addition to the base rubber, the co-crosslinking agent, the crosslinking initiator, and the organic sulfur compound.

The molding conditions for heat pressing the core rubber composition may be determined appropriately depending on the rubber formulation. Generally, the heat pressing is preferably carried out at a temperature ranging from 130° C. to 200° C. for 10 to 60 minutes, or carried out in a two-step heating of heating at a temperature ranging from 130° C. to 150° C. for 20 to 40 minutes followed by heating at a temperature ranging from 160° C. to 180° C. for 5 to 15 minutes.

When the spherical core comprises an intermediate layer, examples of the intermediate layer material include a thermoplastic resin such as a polyurethane resin, an ionomer resin, a polyamide resin, and polyethylene; a thermoplastic elastomer such as a styrene elastomer, a polyolefin elastomer, a polyurethane elastomer, a polyamide elastomer, and a polyester elastomer; and a cured product of a rubber composition. Herein, examples of the ionomer resin include a product obtained by neutralizing at least a part of carboxyl groups in a copolymer composed of ethylene and an α,β-unsaturated carboxylic acid with a metal ion; and a product obtained by neutralizing at least a part of carboxyl groups in a terpolymer composed of ethylene, an α,β-unsaturated carboxylic acid and an α,β-unsaturated carboxylic acid ester with a metal ion. The intermediate layer may further contain a weight adjusting agent such as barium sulfate and tungsten, an antioxidant, and a pigment.

The method for molding the intermediate layer is not particularly limited, and examples thereof include a method which comprises molding the intermediate layer composition into a half shell in advance, covering the spherical body with two of the half shells, and performing compression molding; and a method which comprises injection molding the intermediate layer composition directly onto the spherical body to cover the spherical body.

In case of injection molding the intermediate layer composition onto the spherical body to form the intermediate layer, it is preferred to use upper and lower molds, each having a hemispherical cavity. When molding the intermediate layer by the injection molding method, the hold pin is protruded to hold the spherical body to be covered, and the intermediate layer composition which has been heated and melted is charged and then cooled to form the intermediate layer.

When molding the intermediate layer by the compression molding method, the molding of the half shell may be performed by either a compression molding method or an injection molding method, and the compression molding method is preferable. Compression molding the intermediate layer composition into the half shell may be carried out, for example, under a pressure of 1 MPa or more and 20 MPa or less at a molding temperature of −20° C. or more and +70° C. or less relative to the flow beginning temperature of the intermediate layer composition. If the molding is carried out under the above conditions, the half shell having a uniform thickness can be formed. Examples of the method for molding the intermediate layer by using the half shell include a method which comprises covering the spherical body with two of the half shells and performing compression molding. Compression molding the half shells into the intermediate layer may be carried out, for example, under a pressure of 0.5 MPa or more and 25 MPa or less at a molding temperature of −20° C. or more and +70° C. or less relative to the flow beginning temperature of the intermediate layer composition. If the molding is carried out under the above conditions, the intermediate layer having a uniform thickness can be formed.

It is noted that the molding temperature means the highest temperature where the temperature at the surface of the concave portion of the lower mold reaches from closing the mold to opening the mold. In addition, the flow beginning temperature of the composition can be measured using the thermoplastic resin composition in a pellet form under the following conditions with “Flow Tester CFT-500” available from Shimadzu Corporation.

Measuring conditions: Plunger area: 1 cm², Die length: 1 mm, Die diameter: 1 mm, Load: 588.399 N, Starting temperature: 30° C., and Temperature rising rate: 3° C./min.

The diameter of the spherical core is preferably 34.8 mm or more, more preferably 35.7 mm or more, and even more preferably 36.6 mm or more, and is preferably 42.2 mm or less, more preferably 41.8 mm or less, even more preferably 41.2 mm or less, and most preferably 40.8 mm or less. If the diameter of the spherical core is 34.8 mm or more, the cover is not excessively thick and thus the resilience is better. On the other hand, if the diameter of the spherical core is 42.2 mm or less, the cover is not excessively thin and thus the cover functions better.

### (Construction of Golf Ball)

The construction of the golf ball is not particularly limited, as long as the golf ball comprises a spherical core and a cover covering the spherical core. Examples of the construction of the golf ball include a two-piece golf ball having a single layered spherical core and a cover covering the spherical core; a three-piece golf ball having a spherical core composed of a center and one intermediate layer covering the center, and a cover covering the spherical core; and a multi-piece golf ball having a spherical core composed of a center and two of more intermediate layers covering the center, and a cover covering the spherical core.

The method for forming the cover from the cover composition is not particularly limited, and examples thereof include a method which comprises injection molding the cover composition directly onto the spherical core; and a method which comprises molding the cover composition into a hollow shell, covering the spherical core with a plurality of the shells and performing compression molding (preferably a method which comprises molding the cover composition into a hollow half-shell, covering the spherical core with two of the half-shells and performing compression molding). The golf ball body having the cover formed thereon is ejected from the mold, and is preferably subjected to surface treatments such as deburring, cleaning and sandblast where necessary. In addition, if desired, a paint film or a mark may be formed.

The thickness of the cover is preferably 0.3 mm or more, more preferably 0.4 mm or more, and even more preferably 0.5 mm or more, and is preferably 2.0 mm or less, more preferably 1.8 mm or less, and even more preferably 1.6 mm or less. If the thickness of the cover is 0.3 mm or more, the cover is more easily molded, and if the thickness of the cover is 2.0 mm or less, the core has a relatively large diameter and thus the golf ball has enhanced resilience performance.

The total number of the dimples formed on the cover is preferably 200 or more and 500 or less. If the total number of the dimples is less than 200, the dimple effect is hardly obtained. In addition, if the total number of the dimples exceeds 500, the dimple effect is hardly obtained because the size of the respective dimples is small. The shape (shape in a plan view) of the formed dimples includes, without limitation, a circle; a polygonal shape such as a roughly triangular shape, a roughly quadrangular shape, a roughly pentagonal shape and a roughly hexagonal shape; and other irregular shape. These shapes may be employed solely, or at least two of them may be employed in combination.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 7 μm or more, and even more preferably 9 μm or more, and is preferably 50 μm or less, more preferably 40 μm or less, and even more preferably 30 μm or less. If the thickness of the paint film is 5 μm or more, the paint film is hard to wear off even if the golf ball is used continuously, and if the thickness of the paint film is 50 μm or less, the dimple effect is fully obtained.

The golf ball preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball according to the present disclosure preferably has a mass of 40 g or more and 50 g or less. In light of obtaining greater inertia, the mass is more preferably 44.00 g or more, and particularly preferably 45.00 g or more. In light of satisfying the regulation of USGA, the mass is particularly preferably 45.93 g or less.

When the golf ball according to the present disclosure has a diameter in the range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.4 mm or more, and even more preferably 2.5 mm or more, and is preferably 5.0 mm or less, more preferably 4.5 mm or less, and even more preferably 4.0 mm or less. If the compression deformation amount is 2.0 mm or more, the golf ball is not excessively hard and thus has better shot feeling. On the other hand, if the compression deformation amount is 5.0 mm or less, the resilience is higher.

The FIGURE shows one example of the golf ball according to the present disclosure. The FIGURE is a partially cutaway cross-sectional view showing a golf ball 1 according to one embodiment of the present disclosure. The golf ball 1 comprises a spherical core 2 composed of a center 21 and an intermediate layer 22 covering the center 21, and a cover 3 covering the spherical core 2. A plurality of dimples 31 are formed on the surface of the cover 3. Other portions than the dimples 31 on the surface of the golf ball are lands 32. The golf ball 1 is provided with a paint layer and a mark layer on an outer side of the cover 3, but these layers are not depicted.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method] (1) Slab Hardness (Shore D Hardness)

Sheets with a thickness of about 2 mm were produced by injection molding the intermediate layer composition, the thermoplastic polyurethane or the cover composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (2) Melt Viscosity and Flow Beginning Temperature

The melt viscosity and the flow beginning temperature of the sample in a pellet form was measured with a flow characteristic evaluation apparatus (Flow Tester CFT-500D available from Shimadzu Corporation), and evaluated according to the following evaluation standard. The measuring conditions were a die length of 10 mm, a die hole diameter of 1 mm, a cylinder pressure of 3 MPa, and a temperature of 190° C. The measured values of the formulation containing no component (B) were defined as an index of 100, and the melt viscosity and the flow beginning temperature of each sample were represented by converting the melt viscosity and the flow beginning temperature of each sample into this index. In Tables 3 and 4, the melt viscosity and the flow beginning temperature of the cover composition No. 7 were defined as an index of 100, and the melt viscosity and the flow beginning temperature of each sample were represented by converting the melt viscosity and the flow beginning temperature of each sample into this index. In Table 5, the melt viscosity and the flow beginning temperature of the cover composition No. 21 were defined as an index of 100, and the melt viscosity and the flow beginning temperature of each sample were represented by converting the melt viscosity and the flow beginning temperature of each sample into this index.

### (3) Scratch Resistance

A commercially available pitching wedge was installed on a swing robot, and two different locations of the golf ball were each hit once at a head speed of 36 m/s, the golf balls were hit twice in total. The two hit locations were visually observed and evaluated into 5 grades according to the following standard, and the poorest point was adopted as the evaluation result.
5 points: substantially no damage was recognized.
4 points: there was no visually recognizable damage, but slight damage was recognized when the golf ball was carefully observed on the hand.
3 points: there was visually confirmable damage.
2 points: there was conspicuous damage.
1 point: there was damage in such an extent that the golf ball cannot be reused.

### [Production of Golf Ball] (1)

### Preparation of Rubber Composition

According to the formulation shown in Table 1, the materials were kneaded with a kneading roll to prepare the rubber composition.

TABLE 1
Rubber composition

| | | |
|---|---|---|
| Formulation | BR730 | 100 |
| (parts by mass) | ZN-DA90S | 29.4 |
| | Zinc oxide | 5 |
| | Barium sulfate | Appropriate amount *¹⁾ |
| | PBDS | 0.4 |
| | Dicumyl peroxide | 0.7 |

*¹⁾ The amount of barium sulfate was adjusted such that the golf ball had a mass of 45.6 g.

The materials used in Table 1 are shown as follows.

BR730: high-cis polybutadiene rubber (cis-1,4 bond amount=95 mass %, 1,2-vinyl bond amount=1.3 mass %, Moony viscosity (ML₁₊₄ (100° C.))=55, molecular weight distribution (Mw/Mn)=3) available from ENEOS Materials Corporation
ZN-DA90S: Zinc acrylate (containing zinc stearate in an amount of 10%) available from Nisshoku Techno Fine Chemical Co., Ltd.
Zinc oxide: “Ginrei R” available from Toho Zinc Co., Ltd.
Barium sulfate: “Barium Sulfate BD” available from Sakai Chemical Industry Co., Ltd.
PBDS: Bis (pentabromophenyl)disulfide available from Kawaguchi Chemical Industry Co., Ltd.
Dicumyl peroxide: available from Tokyo Chemical Industry Co., Ltd.

### (2) Preparation of Intermediate Layer Composition

According to the formulation shown in Table 2, the materials were extruded with a twin-screw kneading extruder to prepare the intermediate layer composition in a pellet form.

TABLE 2
Intermediate layer composition

| | | |
|---|---|---|
| Formulation | Surlyn 8150 | 50 |
| (parts by mass) | Himilan AM7329 | 50 |
| | Titanium dioxide | 4 |

| | |
|---|---|
| Slab hardness (Shore D) | 68 |

Surlyn (registered trademark) 8150: sodium ion neutralized ethylene-methacrylic acid copolymer ionomer resin available from Dow Chemical Company
Himilan (registered trademark) AM7329: zinc ion neutralized ethylene-methacrylic acid copolymer ionomer resin available from Dow-Mitsui Polychemicals Co., Ltd.
Titanium dioxide: A-220 available from Ishihara Sangyo Kaisha, Ltd.

### (3) Preparation of Cover Composition

### Thermoplastic Polyurethane No. 1

The thermoplastic polyurethane No. 1 was synthesized as follows.

Polytetramethylene ether glycol (PTMG) (number average molecular weight: 1400) heated to a temperature of 80° C. was charged to dicyclohexylmethane diisocyanate (H₁₂MDI) heated to a temperature of 80° C. Further, dibutyl tin dilaurate was charged thereto in an amount of 0.005 mass % of the total amount of the raw materials (H₁₂MDI, PTMG, and BD), and then the mixture was stirred at a temperature of 80° C. for 2 hours under a nitrogen gas flow. Subsequently, butane diol (BD) heated to a temperature of 80° C. was charged thereto under a nitrogen gas flow, and then the mixture was stirred at a temperature of 80° C. for 1 minute. Next, the reaction liquid was cooled, and degassed under reduced pressure for 1 minute at room temperature. The degassed reaction liquid was spread in a container, and stored at a temperature of 110° C. for 6 hours under a nitrogen gas atmosphere to conduct a urethane-forming reaction, thereby obtaining the thermoplastic polyurethane No. 1. It is noted that the molar ratio of PTMG, H₁₂MDI and BD was PTMG:H₁₂MDI:BD=1:3.81:2.81. The obtained thermoplastic polyurethane No. 1 had a slab hardness of 31 in Shore D hardness.

### Thermoplastic Polyurethane No. 2

As the thermoplastic polyurethane No. 2, a thermoplastic polyurethane (Elastollan (registered trademark) 1195ATR available from BASF) was used. The thermoplastic polyurethane No. 2 comprises 4,4′-diphenylmethane diisocyanate (MDI) as the polyisocyanate constituting the polyurethane, and has a slab hardness of 35 in Shore D hardness.

Next, the thermoplastic polyurethane No. 1 obtained as above was used, and the materials were extruded with a twin-screw kneading extruder according to the formulations shown in Tables 3-5 to prepare the cover compositions in a pellet form.

### (4) Production of Golf Ball

### Golf Balls No. 1 to 21

The rubber composition was heat-pressed in upper and lower molds, each having a hemispherical cavity, to obtain centers having a diameter of 38.5 mm. It is noted that an appropriate amount of barium sulfate was added such that the golf ball had a mass of 45.6 g.

The intermediate layer composition was injection molded on the center to obtain spherical cores. The intermediate layer had a thickness of 1.6 mm. The obtained spherical core was charged into a final mold provided with a plurality of pimples on the cavity surface.

Half shells were obtained from the cover composition by the compression molding method. The spherical core was charged into the final mold and covered with two of half shells to obtain golf balls having a plurality of dimples with an inverted shape of the pimples on the cavity surface formed on the cover. The evaluation results of the obtained golf balls are shown in Tables 3-5.

TABLE 3-1

| Golf ball No | | | | 1 | 2 | 3 | 4 | 5 |
|---|---|---|---|---|---|---|---|---|
| Spherical core | | Diameter (mm) | | 41.7 | 41.7 | 41.7 | 41.7 | 41.7 |
| Cover | No. | | | 1 | 2 | 3 | 4 | 5 |
| composition | Formulation | (A) | Thermoplastic | 99 | 98 | 99 | 98 | 99 |
| | (parts by | | polyurethane No. 1 | | | | | |
| | mass) | (B) | Malic acid | 1 | 2 | — | — | — |
| | | | Citric acid | — | — | 1 | 2 | — |
| | | | Dimethylolbutanoic acid | — | — | — | — | 1 |

| | Himilan 1605 | — | — | — | — | — |
|---|---|---|---|---|---|---|
| | Himilan AM7329 | — | — | — | — | — |
| | Titanium dioxide | 4 | 4 | 4 | 4 | 4 |
| Slab hardness (Shore D) | | 31 | 32 | 31 | 31 | 31 |
| Evaluation | Melt viscosity | 29 | 8 | 92 | 22 | 47 |
| | Flow beginning temperature | 98 | 96 | 100 | 99 | 99 |

| | | | | | | |
|---|---|---|---|---|---|---|
| Cover | Thickness (mm) | 0.5 | 0.5 | 0.5 | 0.5 | 0.5 |
| | Scratch resistance | 4 | 4 | 4 | 4 | 4 |

TABLE 3-2

| Golf ball No | | | | 6 | 7 | 8 | 9 |
|---|---|---|---|---|---|---|---|
| Spherical core | | Diameter (mm) | | 41.7 | 41.7 | 41.7 | 41.7 |
| Cover | No. | | | 6 | 7 | 8 | 9 |
| composition | Formulation | (A) | Thermoplastic | 98 | 100 | 50 | 90 |
| | (parts by | | polyurethane No. 1 | | | | |
| | mass) | (B) | Malic acid | — | — | — | — |
| | | | Citric acid | — | — | — | — |
| | | | Dimethylolbutanoic acid | 2 | — | — | — |

| | Himilan 1605 | — | — | 25 | 5 |
|---|---|---|---|---|---|
| | Himilan AM7329 | — | — | 25 | 5 |
| | Titanium dioxide | 4 | 4 | 4 | 4 |
| Slab hardness (Shore D) | | 31 | 31 | 37 | 33 |
| Evaluation | Melt viscosity | 42 | 100 | 41 | 88 |
| | Flow beginning temperature | 100 | 100 | 91 | 98 |

| | | | | | |
|---|---|---|---|---|---|
| Cover | Thickness (mm) | 0.5 | 0.5 | 0.5 | 0.5 |
| | Scratch resistance | 4 | 4 | 1 | 2 |

TABLE 4-1

| Golf ball No | | | | 10 | 11 | 12 | 13 |
|---|---|---|---|---|---|---|---|
| Spherical core | | Diameter (mm) | | 41.7 | 41.7 | 41.7 | 41.7 |
| Cover | No. | | | 10 | 11 | 12 | 13 |
| composition | Formulation | (A) | Thermoplastic | 98 | 99 | 98 | 96 |
| | (parts by | | polyurethane No. 1 | | | | |
| | mass) | (B) | Succinic acid | 2 | 1 | — | — |
| | | | Adipic acid | — | — | 2 | 4 |
| | | | Tricarballylic acid | — | — | — | — |
| | | | Benzoic acid | — | — | — | — |

| | Titanium dioxide | 4 | 4 | 4 | 4 |
|---|---|---|---|---|---|
| Slab hardness (Shore D) | | 31 | 30 | 30 | 30 |
| Evaluation | Melt viscosity | 2 | 8 | 14 | 8 |
| | Flow beginning temperature | 93 | 96 | 96 | 93 |

| | | | | | |
|---|---|---|---|---|---|
| Cover | Thickness (mm) | 0.5 | 0.5 | 0.5 | 0.5 |
| | Scratch resistance | 4 | 4 | 4 | 4 |

TABLE 4-2

| Golf ball No | | | | 14 | 15 | 16 | 7 |
|---|---|---|---|---|---|---|---|
| Spherical core | | Diameter (mm) | | 41.7 | 41.7 | 41.7 | 41.7 |
| Cover | No. | | | 14 | 15 | 16 | 7 |
| composition | Formulation | (A) | Thermoplastic | 98 | 98 | 96 | 100 |
| | (parts by | | polyurethane No. 1 | | | | |
| | mass) | (B) | Succinic acid | — | — | — | — |
| | | | Adipic acid | — | — | — | — |
| | | | Tricarballylic acid | 2 | — | — | — |
| | | | Benzoic acid | — | 2 | 4 | — |

| | Titanium dioxide | 4 | 4 | 4 | 4 |
|---|---|---|---|---|---|
| Slab hardness (Shore D) | | 30 | 30 | 30 | 31 |
| Evaluation | Melt viscosity | 9 | 48 | 23 | 100 |
| | Flow beginning temperature | 94 | 97 | 97 | 100 |

| | | | | | |
|---|---|---|---|---|---|
| Cover | Thickness (mm) | 0.5 | 0.5 | 0.5 | 0.5 |
| | Scratch resistance | 4 | 4 | 4 | 4 |

TABLE 5

| Golf ball No | | | | 17 | 18 | 19 | 20 | 21 |
|---|---|---|---|---|---|---|---|---|
| Spherical core | | Diameter (mm) | | 41.7 | 41.7 | 41.7 | 41.7 | 41.7 |
| Cover | No. | | | 17 | 18 | 19 | 20 | 21 |
| composition | Formulation | (A) | Thermoplastic | 96 | 98 | 98 | 98 | 100 |
| | (parts by | | polyurethane No. 2 | | | | | |
| | mass) | (B) | Dimethylolbutanoic acid | 4 | — | — | — | — |
| | | | Succinic acid | — | 2 | — | — | — |
| | | | Adipic acid | — | — | 2 | — | — |
| | | | Benzoic acid | — | — | — | 2 | — |

| | Titanium dioxide | 4 | 4 | 4 | 4 | 4 |
|---|---|---|---|---|---|---|
| Slab hardness (Shore D) | | 35 | 36 | 35 | 35 | 35 |
| Evaluation | Melt viscosity | 69 | 75 | 38 | 86 | 100 |
| | Flow beginning temperature | 98 | 92 | 98 | 100 | 100 |

| | | | | | | |
|---|---|---|---|---|---|---|
| Cover | Thickness (mm) | 0.5 | 0.5 | 0.5 | 0.5 | 0.5 |
| | Scratch resistance | 3 | 3 | 4 | 3 | 2 |

The materials used in Tables 3-5 are shown as follows.
Malic acid: available from Tokyo Chemical Industry Co., Ltd.
Citric acid: available from Tokyo Chemical Industry Co., Ltd.
Dimethylolbutanoic acid: available from Tokyo Chemical Industry Co., Ltd.
Succinic acid: available from Tokyo Chemical Industry Co., Ltd.
Adipic acid: available from Tokyo Chemical Industry Co., Ltd.
Tricarballylic acid: available from Tokyo Chemical Industry Co., Ltd.
Benzoic acid: available from Tokyo Chemical Industry Co., Ltd.
Himilan (registered trademark) 1605: sodium ion neutralized ethylene-methacrylic acid copolymer ionomer resin available from Dow-Mitsui Polychemicals Co., Ltd.
Himilan AM7329: zinc ion neutralized ethylene-methacrylic acid copolymer ionomer resin available from Dow-Mitsui Polychemicals Co., Ltd.
Titanium dioxide: A-220 available from Ishihara Sangyo Kaisha, Ltd.

The covers of the golf balls No. 1 to 6 and 10 to 20 were formed from the cover compositions No. 1 to 6 and 10 to 20 containing (A) the thermoplastic polyurethane and (B) the carboxylic acid as the resin component.

The covers of the golf balls No. 7 and 21 were formed from the cover compositions No. 7 and 21 containing (A) the thermoplastic polyurethane and no (B) the carboxylic acid as the resin component.

The cover of the golf ball No. 8 or 9 was formed from the cover composition No. 8 or 9 containing (A) the thermoplastic polyurethane and an ionomer resin (a metal ion neutralized product of an olefin-unsaturated carboxylic acid copolymer or a metal ion neutralized product of an olefin-unsaturated carboxylic acid-unsaturated carboxylic acid ester copolymer).

The melt viscosity of the cover compositions No. 1 to 6 and 10 to 16 for forming the covers of the golf balls No. 1 to 6 and 10 to 16 is lower than that of the cover composition No. 7 for forming the cover of the golf ball No. 7. Thus, the covers of these golf balls No. 1 to 6 and 10 to 16 have improved moldability.

In addition, the covers of the golf balls No. 1 to 6 and 10 to 16 have higher scratch resistance than the covers of the golf balls No. 8 and 9, showing that lowering of the scratch resistance has been inhibited by using (B) the carboxylic acid.

The cover compositions No. 17 to 20 forming the covers of the golf balls No. 17 to 20 have lower melt viscosity than the cover composition No. 21 forming the cover of the golf ball No. 21. Thus, the covers of these golf balls No. 17 to 20 have enhanced moldability.

In addition, the covers of the golf balls No. 17 to 20 have better scratch resistance than the cover of the golf ball No. 21, and thus if (B) the carboxylic acid is used, scratch resistance is enhanced.

### Embodiments of the Present Disclosure

The preferable embodiment (1) of the present disclosure is a golf ball comprising a spherical core and a cover covering the spherical core, wherein the cover is formed from a cover composition containing (A) a thermoplastic polyurethane and (B) a carboxylic acid having a molecular weight of 1000 or less as a resin component.

The preferable embodiment (2) of the present disclosure is the golf ball of the preferable embodiment (1), wherein a mass ratio ((A)/(B)) of (A) the thermoplastic polyurethane to (B) the carboxylic acid in the resin component ranges from 70/30 to 99.9/0.1.

The preferable embodiment (3) of the present disclosure is the golf ball of the preferable embodiment (1) or (2), wherein a polyisocyanate constituting (A) the thermoplastic polyurethane includes an alicyclic diisocyanate and/or an aromatic diisocyanate.

The preferable embodiment (4) of the present disclosure is the golf ball of the preferable embodiment (3), wherein the polyisocyanate includes at least one diisocyanate selected from the group consisting of 4,4′-dicyclohexylmethane diisocyanate, 1,3-bis(isocyanatomethyl)cyclohexane, isophorone diisocyanate, trans-1,4-cyclohexane diisocyanate, 4,4′-diphenylmethane diisocyanate and toluene diisocyanate.

The preferable embodiment (5) of the present disclosure is the golf ball of the preferable embodiments (1) to (4), wherein (B) the carboxylic acid has two or more and 10 or less carboxy groups in the molecule.

This application is based on Japanese patent application No. 2024-229112 filed on Dec. 25, 2024 and Japanese patent application No. 2025-137041 filed on Aug. 20, 2025, the contents of which are hereby incorporated by reference.

1. A golf ball comprising a spherical core and a cover covering the spherical core, wherein the cover is formed from a cover composition containing (A) a thermoplastic polyurethane and (B) a carboxylic acid having a molecular weight of 1000 or less as a resin component.

2. The golf ball according to claim 1, wherein a mass ratio ((A)/(B)) of (A) the thermoplastic polyurethane to (B) the carboxylic acid in the resin component ranges from 70/30 to 99.9/0.1.

3. The golf ball according to claim 1, wherein a polyisocyanate constituting (A) the thermoplastic polyurethane includes an alicyclic diisocyanate and/or an aromatic diisocyanate.

4. The golf ball according to claim 3, wherein the polyisocyanate includes at least one diisocyanate selected from the group consisting of 4,4′-dicyclohexylmethane diisocyanate, 1,3-bis(isocyanatomethyl)cyclohexane, isophorone diisocyanate, trans-1,4-cyclohexane diisocyanate, 4,4′-diphenylmethane diisocyanate and toluene diisocyanate.

5. The golf ball according to claim 1, wherein (B) the carboxylic acid has two or more and 10 or less carboxy groups in the molecule.

6. The golf ball according to claim 1, wherein (B) the carboxylic acid has a carboxy group in an amount ranging from 1 mmol/g to 30 mmol/g.

7. The golf ball according to claim 1, wherein (B) the carboxylic acid includes at least one member selected from the group consisting of malic acid, citric acid, dimethylolbutanoic acid, succinic acid, adipic acid, tricarballylic acid, and benzoic acid.

8. The golf ball according to claim 1, wherein the molecular weight of (B) the carboxylic acid ranges from 50 to 1000.

9. The golf ball according to claim 1, wherein a mass ratio ((A)/(B)) of (A) the thermoplastic polyurethane to (B) the carboxylic acid in the resin component ranges from 90/10 to 99/1.

10. The golf ball according to claim 1, wherein the cover composition has a slab hardness ranging from 25 to 40 in Shore D hardness.

11. The golf ball according to claim 1, wherein a molar amount of (B) the carboxylic acid in 100 g of the resin component ranges from 0.1 mmol to 60 mmol.
